(19) United States
(12) Patent Application Publication
(10) Pub. No.: US 2002/0056125 A1
(43) Pub. Date: May 9, 2002

(54) Multi-tier buffering system and method which combines video, data, and voice packets

(76) Inventors: Winston W. Hodge, Yorba Linda, CA (US); William H. Darnall, Costa Mesa, CA (US)

Correspondence Address: Michael A. Kerr, P.O. Box 2345, Stateline, NV, 89449, US

(21) Appl. No.: 09/823,179

(22) Filed: Mar. 29, 2001

Related U.S. Application Data
(63) Continuation-in-part of application No. 09/162,313, filed on Sep. 28, 1998, now abandoned.
(63) Continuation-in-part of application No. 09/761,205, filed on Jan. 16, 2001.
(63) Continuation-in-part of application No. 09/761,208, filed on Jan. 16, 2001.

(51) Int. Cl. H04N 7/173

(52) U.S. Cl. 725/87

(57) ABSTRACT

The present invention is a digital headend system for communicating a plurality of video packets, data packets, voice packets, and control packets. The system includes a buffering module, a re-packetization module, and a synchronization module. The buffering module receives the plurality of video packets, data packets, voice packets, control packets or any combination of packets. Preferably, the buffering module generates a destination address which identifies a particular re-packetization module. The identified re-packetization module is in communication with the buffering module. The first re-packetization module combines the plurality of video packets, data packets, voice packets, control packets or any combination thereof. The synchronizing module receives the re-packetization output and generates a synchronous output stream having the plurality of video packets, data packets, voice packets, control packets or any combination thereof. Preferably, the synchronous output stream is comprised of MPEG transport packets.

The present invention also provides a method for communicating the plurality of video packet, data packet, voice packet, control packets, or any combination thereof. The method provides for receiving the plurality of video, data, voice, control packets or any combination thereof. The method then proceeds to communicate the plurality of video packets, data packets, voice packets, control packets, or any combination thereof across a shared bus. The plurality of video packets, data packets, voice packets, control packets or any combination thereof which are communicated across said shared bus are managed by a processor resident on the re-packetization module.

The present invention is a Continuation-In-Part of patent application Ser. No. 09/162,313 filed on Sep. 28, 1998 and is a Continuation-In-Part of patent application Ser. No. 09/761,205 filed on Jan. 16, 2001 and a Continuation-In-Part of patent application Ser. No. 09/761,208 filed on Jan. 16, 2001.

### BACKGROUND OF THE INVENTION

1. Field of the Invention

The present invention relates to a multi-tier buffering system and method for a digital headend. More particularly, the present invention is a digital headend having a multi-tier buffering system and method which communicates video, data or voice signals or any combination.

2. The Prior Art

The prior art teaches the use of specialized system to communicate video signals, and separate specialized system to communicate data signals, and a separate specialized system to communicate voice signals. FIG. 1 shows an illustrative prior art digital headend system 10 which is configured to provide two-way broadband communications. The data communicated and processed by the digital headend 10 includes analog video 12, Internet data 14, and digital video 16. An analog video signal 12 is received by a first upconverter 18. Those skilled in the art shall appreciate that the upconverter provides the appropriate RF communication frequency range for downstream transmission via a cable and/or HFC distribution network to a set top box. Additionally, those skilled in the art shall also appreciate that during upstream communications, a QPSK demodulator (not shown) is used to demodulate the upstream signals for communication with the digital headend.

In the digital headend system 10, the Internet data 14 received by the digital headend 10 is communicated to a central processing unit (CPU) 20 and a point-of-presence (POP) cable modem termination system (CMTS) 22. The CPU 20 performs the function of providing menuing information, conducting accounting and billing, and managing the conditional access control. The CMTS 22 is a data-over-cable service interface specification (DOCSIS) compliant cable headend router which provides an Internet Protocol (IP) standard which allows a plurality of cable modems (not shown) to communicate with the CMTS 22. Downstream data from the CMTS 22 is then communicated to a quadrature amplitude modulation (QAM) modulator 24. The QAM modulator 24 provides a method for modulating digital signals onto an intermediate RF carrier signal involving both amplitude and phase coding which is then communicated to a second upconverter 26. As previously mentioned, the upconverter 26 provides the function of translating QAM modulated data at the appropriate frequency as a plurality of downstream signals. Upstream signals 28 generated by a cable modem (not shown) are then received by a Quadrature Phase-Shift Keying (QPSK) demodulator 30 on the digital headend 10. The QPSK demodulator 10 demodulates digital signals from a RF carrier signal using four phase states to code two digital bits. The digital output from the QPSK demodulator 30 is communicated to the CPU 20 and an out-of-band QPSK modulator 32. The out-of-band (OOB) QPSK modulator 32 provides bi-directional signaling for broadband communications as would be appreciated by those skilled in the art. The OOB QPSK modulator 32 is operatively coupled to an upconverter 34.

The digital video data 16 received by the digital headend 10 is received by the control computer 36 and by a video server 38. Under the guidance of the control computer 36, the video server 38 transmits digital video signals to a QAM modulator 40 which communicates the modulated data to an upconverter 42. The upconverter 42 translates the digital video data at the appropriate downstream frequency for subsequent transmission to a set-top box (not shown). Upstream communications generated by the digital set-top box are communicated to a QPSK demodulator (not shown) which is dedicated to digital video.

The control computer 36 manages the dynamics of digital headend and the Internet data, digital video data and analog data by processing the upstream communications from the set top boxes or cable modems. Further still the control computer 36 determines what movies are loaded onto the video server 38.

It shall be appreciated by those of ordinary skill in the art that an upconverter level adjuster 42 is employed to adjust the level for RF signals communicated by each respective upconverter 18, 34, 42, and 26.

Although not shown, telephony services may also be included in the digital headend shown in FIG. 1. If telephony services were added to the headend described above, they could be provided with a conventional switched telephony system or a voice over IP (VoIP) telephony system. The prior art telephony systems which interface with the digital headend 10 would generally employ downstream QAM modulators with upconverters and upstream QPSK demodulators.

The prior art digital headend system 10 has little or no modularity built into the system. Modularity is defined as the property which provides functional flexibility to a computer system by allowing for the assembling of discrete software units which can be easily joined or arranged with other hardware parts or software units. For example, the prior art digital headend system includes a CMTS 22 which receives Internet data in the form of Ethernet frames using the IP protocol and employs an MPEG-2 transport stream. Additionally, the prior art digital headend 10 includes the digital video 16 which is received as an MPEG-2 transport stream and this MPEG-2 transport stream is also used to communicate the digital video 16 to a set-top box (not shown). Although Internet data and digital video data use the same MPEG-2 transport stream, these two data streams have not been cost effectively integrated. For the co-existence of these two data streams to occur a separate stand alone intermediary hardware and software solution is necessary. The intermediary hardware and software solution does not provide a modular platform.

Additionally, U.S. Pat. No. 6,028,860 titled Prioritized Virtual Connection Transmissions In A Packet To ATM Cell Cable Network teaches a bi-directional communications system in a CATV network utilizing cell-based Asynchronous Transfer Mode (ATM) transmissions. Packet data existing in any one of several different formats are first converted into ATM cells by a headend controller. Individual cells are then assigned a virtual connection by the headend controller. Based on the virtual connection, the cells can be prioritized and routed their intended destinations. The cells are transmitted in a shared radio frequency spectrum over a standard cable TV network. A subscriber terminal unit demodulates the received RF signal and processes the cells for use in a computer. Likewise, computers may transmit packet data to their respective subscriber terminal units which are sent to the headend controller over the same CATV network.

The '860 patent provides communications with ATM cells and requires a subscriber terminal unit and a computer, and results in an expensive set-top box system. Furthermore, the patent does not optimize the sharing of available resources in the digital cable headend which also adds to the expense of the system.

Therefore, it would be beneficial to provide a digital headend which is configured to combine video, data and voice signals without a separate stand alone intermediary hardware and software solution is necessary

It would also be beneficial to provide a digital headend which optimizes the use of system resources and is capable of being used with legacy systems.

Finally, it would be beneficial provide a digital headend which is configured to generate a synchronous output of video, data, or voice packets from a plurality of video, data or voice signals.

### SUMMARY OF THE INVENTION

The present invention is a digital headend system for communicating a plurality of video packets, data packets, voice packets, control packets, or any combination thereof. The system includes a buffering module, a re-packetization module, and a synchronization module.

The buffering module receives the plurality of video packets, data packets, voice packets, control packets or any combination thereof. The buffering module generates a destination address which identifies a particular re-packetization module for communicating the video packets, data packets, voice packets, control packets or combination thereof. The buffering may also identify other re-packetization modules.

The identified re-packetization module is in communication with the buffering module. The first re-packetization module combines the plurality of video packets, data packets, voice packets, control packets or any combination thereof to generate a first re-packetization module output.

The synchronizing module receives the re-packetization output and generates a synchronous output stream having the plurality of video packets, data packets, voice packets, control packets or any combination thereof. Preferably, the synchronous output stream is communicated using one channel. Additionally, it is preferable that the synchronous output stream be comprised of MPEG transport packets.

The present invention also provides a method for communicating the plurality of video packets or the plurality of data packets or the plurality of voice packets or the plurality of control packets or any combination thereof.

The method provides for receiving the plurality of video packets, data packets, voice packets, control packets or any combination thereof. The method provides for the buffering of the plurality of video packets, data packets, voice packets, control packets or any combination thereof. Additionally a re-packetization module is identified to communicate the plurality of video packets, data packets, voice packets, control packets or any combination thereof.

The method then proceeds to communicate the plurality of video packets, data packets, voice packets, control packets or any combination thereof across a shared bus.

The plurality of video packets, data packets, voice packets, control packets or any combination thereof which are communicated across the shared bus are managed by a processor resident on the re-packetization module. The processor combines the plurality of video packets, data packets, voice packets, control packets or any combination thereof and generates a re-packetization output.

The re-packetization output is then used to generate a synchronous output stream with the synchronizing module. The synchronous output stream includes the plurality of video packets, data packets, voice packets, control packets or any combination thereof.

### BRIEF DESCRIPTION OF DRAWING FIGURES

FIG. 1 is a prior art two-way broadband digital headend system.

FIG. 2 is a block diagram of a highly integrated computer controlled headend having a plurality of downstream modules.

FIG. 3 is a block diagram of a downstream module.

FIG. 4 is a flow diagram of a downstream module in communication with a smart network interface module.

FIG. 5 is a flow diagram of insertion of packets, bits, and bytes to an existing transport stream.

FIG. 6 is process flow diagram of the multi-tier buffering system

FIG. 7a is flow diagram of the data flow within the digital headend.

FIG. 7b is a flow diagram of the multi-tiered buffering system.

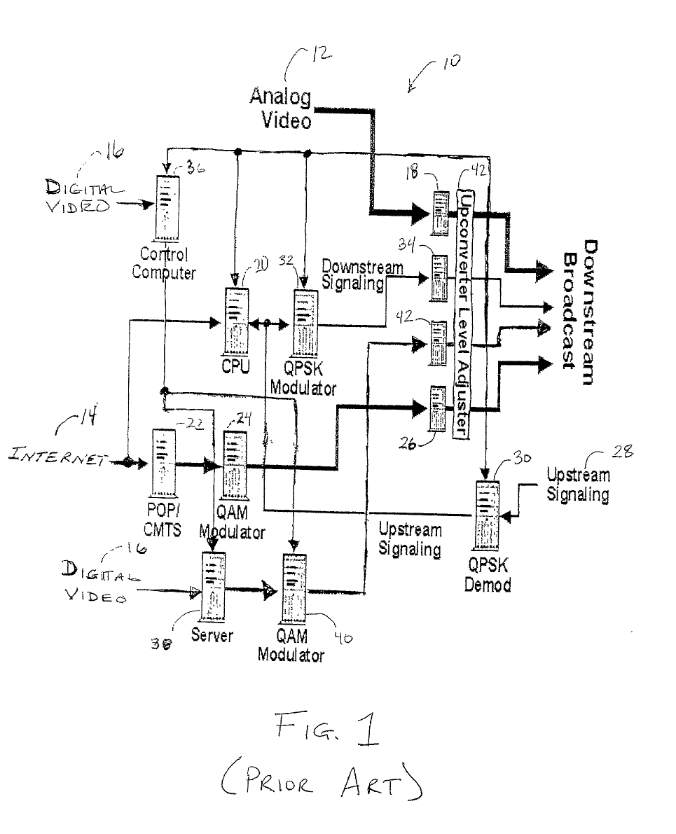

### DETAILED DESCRIPTION OF THE INVENTION

Persons of ordinary skill in the art will realize that the following description of the present invention is illustrative only and not any way limiting. Other embodiments of the invention will readily suggest themselves to such skilled persons having the benefit of this disclosure.

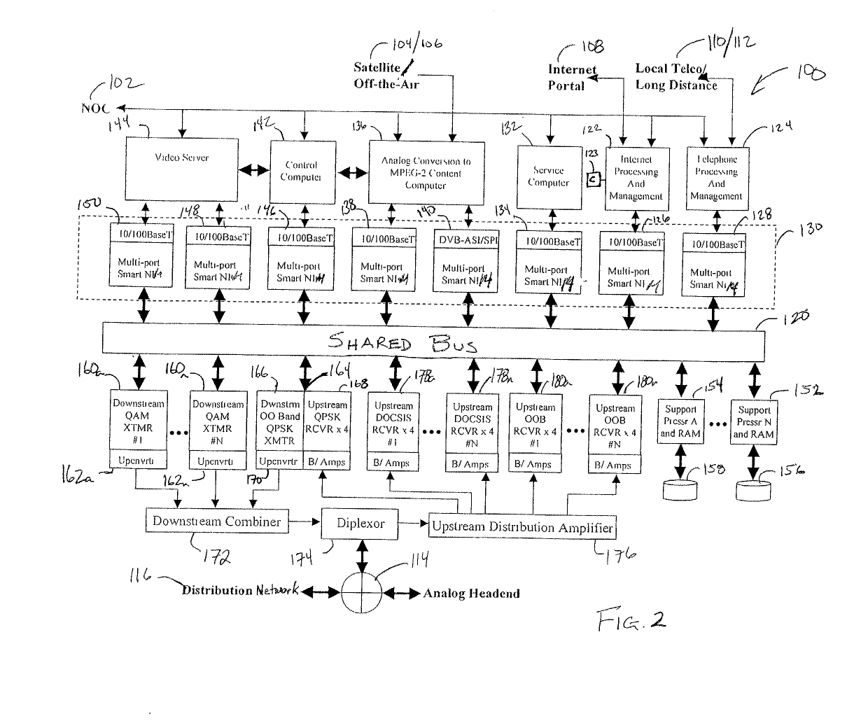

Referring to FIG. 2 there is shown a block diagram of a highly integrated computer controlled headend 100 having a plurality of downstream modules. The highly integrated computer controlled headend 100 is also referred to as a digital headend 100. The programmable downstream module of the present invention is employed in the digital headend.

The digital headend 100 communicates with a Network Operation Center 102, and receives satellite 104 and of-the-air 106 transmissions. Additionally, the digital headend 100 communicates with an Interner portal and with a local telephone company 110 and provides long distance 112 services. It shall be appreciated that the term “video” refers to video signals or video control signals which are communicated by the network operations center 102, satellite 104 and off-the-air 106 transmission. The term “data” refers to the use of the TCP/IP protocol for the communications of Internet, World Wide Web, and any other such communications systems using the TCP/IP protocol. The term “voice” refers to telephony systems and includes IP type telephony systems as well as conventional switched telephony systems.

In the preferred embodiment, the highly integrated computer controlled headend 100 provides the following functions: communicating with a Network Operations Center (NOC) 102; receiving signals from a satellite 104; receiving off-air transmission 106; receiving and transmitting Internet data 108; receiving and transmitting local telephony signals 110 and long distance telephony signals 112, and communicating with a headend system combiner 114.

To perform the functions described above the highly integrated computer controlled headend 100 performs video, data, and voice processing. The video, data, and voice processing performed by the highly integrated computer controlled headend 100 include downstream and upstream signal processing, i.e. bi-directional signal processing. Additionally, the highly integrated computer controlled headend 100 includes a control system which is configured to regulate or “control” the downstream and upstream signal processing.

The highly integrated computer controlled headend 100 comprises a shared bus 120 that permits a high level of integration between video, data and voice signals. Digital video signals provide the representation of video signals in a digital format. Digital data signals are generally communicated in compliance with the data-over cable service interface specification (DOCSIS). DOCSIS is the cable modem standard produced by an industry consortium led by Cable Labs. It shall be appreciated by those skilled in the art having the benefit of this disclosure that the MPEG-2 transport stream is, preferably, employed for communicating said digital video signals and said digital data signals. Voice signals are generally communicated as voice over Internet Protocol (VoIP) or conventional switched telephony. VoIP provides the ability carry normal telephony-style voice over an IP-based Internet with POTS-like voice quality. It shall be appreciated by those skilled in the art having the benefit of this disclosure that VoIP can be represented as either digital data signals. It shall also be appreciated by those skilled in the art that VoIP voice signals are generally communicated using the MPEG-2 transport stream, however, conventional switched telephony systems may also be used with the digital headend 100. Voice signals refers to both VoIP and conventional switched telephony.

Preferably, the shared bus 120 is a parallel bus such as a 32-bit Compact PCI-bus. The 32 bit Compact PCI-bus allows for the use of a combination of off-the-shelf systems which are integrated with downstream modules and upstream modules of the present invention. Since the Compact PCI-bus can only hold a fixed number of modules, a plurality of Compact PCI chassis may be used to satisfy additional system demands, and thereby provide for system scalability. It shall be appreciated by those skilled in the art having the benefit of this disclosure that a 64-bit Compact PCI bus or any other parallel bus may be used. Alternatively, the shared bus 120 may be a high speed serial bus. Regardless of the type of bus employed, it is essential that the bus architecture which provides for the sharing of resources operates in a manner which is open and scalable.

The downstream content which is processed by the highly integrated computer controlled headend 100 is generated by a network operations center (NOC) 104, a satellite or off-the-air broadcast 106, an Internet Portal 108, a local telephone company portal 110 and a long distance telephone company portal 112. The NOC 104 provides a variety of different types of information which include content streams for the highly integrated computer controlled headend 100, security procedures such as cryptography, billing information, and post processing work. The satellite or off-the-air broadcast 106 provides the video signals which are communicated using well known RF signalling methods. The portals, i.e. Internet portal 108, local telephone company 110 and long distance telephone company 112, receive and transmit information to the highly integrated computer controlled headend 100.

An Internet processing and management system 122 is in communication with the NOC 104 and the Internet portal 108. A telephone processing and management system 124 is in communication with the NOC 104, the local telephone company portal 110 and long distance phone company portal 112. Well known Internet and telephone processing and management systems 122 and 124, respectively, have been developed by companies such as Cisco Systems and Texas Instruments. The Internet processing and management system 122 provides processing and management for Internet data. The Internet processing and management system may also be operatively coupled to a caching system 123 which stores Internet information that is regularly requested by the digital headend 100. A caching system 123 may include software such as software developed by Inktomi and operate using Sun Microsystem servers. The telephone process and management system 124 provides processing and management of either switched telephony or VoIP signals.

Both of the Internet and telephony processing and management systems 122 and 124, respectively, are operatively coupled to the shared bus 120 via a smart network interface module (NIM) 126 and 128, respectively. Preferably, the smart NIMs 126 and 128 provides a first level of buffering which optimizes the bus transfer rate of the shared bus 120. Alternatively, the smart NIMs 126 and 128 reside on a plurality of downstream modules.

Preferably, each smart NIM comprises a processor or programmable logic or ASIC and a memory which are configured to generate a destination address which identifies a particular downstream module. The destination address is used to provide each packet of video, data and voice with the identity of the downstream module which will be processing the packets of video, data, voice, or control information, or any combination thereof. Additionally, a memory preferably functions as a buffer for the video, data, voice, or control packets until the destination address is determined for these packets.

It shall be appreciated by those of ordinary skill in the art that a “bus” is a series of tiny wires that run from one chip to another. The shared bus 120 of the present invention provides an architecture which allows the headend 100 to share headend resources. The shared bus includes address, data and control elements which are communicated in a serial bus or parallel bus. A serial bus has fewer wires and operates generally at a higher speed. A parallel bus has more wires and generally operates at a slower speed. Any combination of a serial bus and parallel bus may also be employed. Preferably, the shared bus employs a 32-bit Compact PCI bus which is a parallel bus.

Although the preferred embodiment of the present invention employs a smart NIM configured to optimize communications across the shared bus, other devices which do not employ a CPU but which provide buffering may also be employed. These devices may include only memory devices which are configured to buffer video, data and voice signals. For purposes of this patent application, the term smart NIM is not restricted to NIM having a CPU. As described in this patent application, the term the smart NIM refers to a controller which is configured to buffer digital information received by that smart NIM. Preferably, the buffered digital information is optimized by the smart NIM for transfer across the shared bus.

The smart NIMs 126 and 128 are coupled to the Internet and telephony processing and management system 122 and 124, respectively, and provide the first level buffering which controls the blocks of data which are communicated across the shared bus 120. Preferably, the smart NIMs 126 and 128 efficiently manage the transmission of bus traffic using block transfer to communicate data across the shared bus 120. By optimizing the data being transferred across the shared bus 102, the smart NIM avoids efficiency losses caused by serial connections between disparate system components. Judicious data management provided by the smart NIM optimizes communications within the highly integrated computer controlled headend 100 by managing the communications between the various components of the highly integrated computer controlled headend 100.

A service computer 132 is in communication with the NOC 104. The service computer 132 performs the function of managing the conditional access, billing and configuration management. Configuration management determines the type of equipment deployed and its maintenance history. The service computer is a robust dedicated general purpose computer. Communications with the shared bus system 132 are accomplished with a Smart NIM 134 which provides appropriate buffering to optimize communications along the Compact PCI bus 120 as described in the body of this specification.

An MPEG content computer 136 receives the satellite 104 and off-the-air signals 106 and converts these analog signals to digital video signals using, preferably, an MPEG digital format. The MPEG content computer 136 also receives ad insertion feeds and converts these feeds to a digital content stream which are inserted into the local (off-the-air) content and the satellite feed content 106. The digital content generated by the MPEG content computer 136 is then fed to a 10/100 BaseT interface which, preferably, provides a MPEG-2 transport stream to a smart NIM 138. Additionally, the digital content generated by the MPEG content computer 136 is also fed to a DVB-ASI/SPI interface operatively coupled to a smart NIM 138 which also uses a MPEG-2 transport stream. As previously described, the smart NIM provides the first level buffering which optimizes the bus transfer rate to the shared bus 120.

The control computer 142 receives control information provided by the NOC 104. The control information includes a program guide, generated at the NOC 104, which is communicated by the highly integrated computer controlled headend 100 to a plurality of set-top boxes 118a through 118n. The control computer 142 also performs the real-time functions of content management and resource allocation for the MPEG content streams. The control computer 142 is a relatively quick and robust computer system compared to the service computer 122. The content management regulated by the control computer 142 comprises the MPEG content from a video server 144 and the MPEG content computer 136. The resource allocation provided by the control computer 142 manages system resources for the highly integrated computer controlled headend 100. The control computer is operatively coupled via a 10/100 BaseT interface to a smart NIM 146 which is operatively coupled to the shared bus 120.

The video server 144 receives content from the NOC 104 or from the MPEG content computer 136. The video server 144 provides local storage for digital video. As previously described, the video server 144 is managed by the control computer 142. The output from the video server 144 is communicated to smart NIMs 148 and 150. The smart NIMs 148 and 150 provide the first level buffering which optimizes the bus transfer rate to the shared bus 120.

A plurality of support processors 152 and 154 having appropriate memory resources are resident as modules which are configured to interface with the shared bus 120. Each support processor 152 and 154 is operatively coupled to disk drives 156 and 158, respectively. Each of the support processors 152 and 154 operate as an individual computer which are operatively coupled to the shared bus 120. The support processors 152 and 154 contain configuration information for the upstream and downstream modules (described below). Additionally the support processors 152 and 154 and their associated disk drives 156 and 158 also contain software programs for the upstream and downstream modules. The support processors 152 and 154 provide the preferred alternative to managing the addition of software to the highly integrated computer controlled headend 100. By way of example and not of limitation, hundreds of utility programs keep track of time of day, memory addresses, and are responsible for managing the downloading of software to the upstream and downstream modules. When loading software onto the downstream and upstream modules, it is important to avoid loading viruses or other types of software onto the system which will affect the performance of the highly integrated computer controlled headend 100 and the set-top boxes which receive the new software.

More particularly, the process for installing software onto the downstream modules or upstream modules or the set-top boxes includes first receiving software on one of the support processors 152 or 154. The received software is then tested locally on the support processor 152 or 154 to make sure the software is “clean”. A downstream or upstream module is then taken out of service and then loaded with the new software. Diagnostics are performed to make sure the module is operating properly. Once the module has successfully passed the self-test, the module is brought back on-line. When the module is taken off-line and put back on-line, one of the support processors communicates the status of the module to the service computer 132. After the completion of loading the software on the appropriate downstream module or upstream module, the support processor may then move onto the next module and proceed in a similar manner as described above. In general each support processor 152 and 154 communicates the status on each of the downstream and upstream modules to the service computer 132 which in turn communicates this information to the network operations center 104.

The highly integrated computer controlled headend 100 also includes an advanced digital down stream data module 160a through 160n and 166. The advanced digital downstream data modules 160a through 160n provide a highly integrated QAM functionality which improves the management of downstream data, increases reliability for the transmission of the downstream data, and provides for better utilization of available bandwidth. The advanced digital downstream data modules 160a through 160n each comprise a dedicated high-speed embedded processor, an onboard memory, an upconverter, and an automatic level adjuster. The dedicated processor is configured to track the contents of the downstream video, data and voice information and provide refinement in control information. The refinements of control information by the dedicated processor permits data sharing, data muxing, increased security, and improved downstream bandwidth management. It shall be appreciated by those skilled in the art having the benefit of this disclosure that the smart network interface module may be a discrete module operatively coupled to the shared bus or the smart network interface module may be resident on the downstream module, or any combination thereof.

Each advanced digital downstream data module 160a through 160n is operatively coupled to an upconverter 162a through 162n, respectively. The upconverters 162a through 162n have a small footprint and are a highly integrated component of each of the advanced digital downstream data modules 160a through 160n. The small footprint for the upconverter lets the upconverter reside as an extension of the advanced digital downstream data module 160a through 160n, thereby permitting the advanced downstream data module having an upconverter to fit with a single module space shared bus chassis.

The advanced digital downstream data module 160a through 160n is configured to handle video, data and voice signals on the same QAM module. By way of example, and not of limitation, the advanced digital downstream module can be configured to perform CMTS DOCSIS-compliant modem functions and/or digital video transmissions simultaneously. The advanced digital downstream module may also be managed by software which is configured to mix and integrate different types of data, e.g. IP data signals, digital video signals, within a single platform using the MPEG-2 transport stream.

Preferably, the present invention also includes a bi-directional signaling and control module 164 which includes a downstream out-of-band Quadrature Phase Shift Keying (QPSK) transmitter 166 and an upstream QPSK receiver 168. The bi-directional signaling and control module 164 provides the two-way signaling necessary to communicate between the highly integrated computer controlled headend 100 and a plurality of set-top boxes (not shown). The bi-directional signaling and control module 164 includes a powerful embedded CPU which permits local control and management. The downstream out-of-band QPSK transmitter 166 is operatively coupled to an upconverter 170. It shall be appreciated by those of ordinary skill in the art that during out-of-band communications a plurality of control signals are communicated in portions of the broadband spectrum that does not contain program content.

A downstream combiner 172 receives the output from upconverter 162a through 162n and 170 performs the function of combining downstream signals. The downstream combiner 172 is an isolation device which sets gains for downstream transmission, i.e. tilt compensation, and provides system reliability with diagnostic tools. The downstream combiner 172 includes a plurality of passive and active devices which combine the upconverter 162a through 162n and 170 output. Preferably, the downstream combiner 178 monitors the “health” of each downstream encoder 160a thorugh 160n, the downstream out-of-band QPSK transmitter 166, and their respective upconverters 162a through 162n and 170.

A diplexer 174 receives signals from the downstream combiner 170. The diplexer 174 is a high pass/low pass filter which “high” passes downstream information and “low” passes upstream information. The diplexer receives “high” pass signals from the downstream combiner 172 and submits these signals to a headend system combiner 114. The headend system combiner 114 is configured to permit combining the signals generated by an existing analog cable headend (not shown) with the modulated digital headend output generated by highly integrated computer controlled headend 100.

The distribution network 116 receives output from the headend system combiner 114. It shall be appreciated by those of ordinary skill in the art that the distribution network 116 includes a plurality of amplifiers and set-top boxes or modems. The set-top boxes are configured to receive signals from the highly integrated computer controlled headend 100 and the analog headend. Upstream communications generated by the set-top boxes are communicated to headend system 114 which submits the upstream communication to diplexer 174. The diplexer 174 low passes the upstream communications to an upstream distribution amplifier 176.

The upstream distribution amplifier 176 receives upstream signals from the diplexer 174. The upstream distribution amplifier 176 provides impedance matching, inverse tilt compensation, and diagnostic services for the distribution network. The upstream distribution amplifier does not demodulate upstream signals.

A plurality of upstream receiver modules 168, 178a through 178n, and 180 through 180n accept upstream data signals from the upstream distribution amplifier 176. Upstream data signals are communicated in the form of packets which contain the Internet data, telephony data, and system status/control data. Preferably, each upstream receiver module 168, 178a through 178n, and 180 through 180n includes the following components, an upstream tuner, a PCI interface, a CPU and memory support, encryption circuits, and buffer amplification. More particularly, upstream receiver module 168 is operatively coupled with the downstream out-of-band QPSK transmitter 166 and receives upstream communications associated with the data signals generated by the downstream out-of-band QPSK transmitter 166. The upstream receiver modules 178a through 178n receive upstream DOCSIS data and demodulated the upstream signal. The upstream receiver modules 180a through 180n receive out-of-band upstream communications from the distribution network and demodulates the upstream signal. Each upstream receiver module modules 168, 178a through 178n, and 180 through 180n is operatively coupled to the shared bus 120, and submit their demodulated output to control computer 142.

Preferably, a 32 bit Compact PCI-bus is employed. Additionally other parallel buses including a 64-bit bus, 128-bit bus, 256-bit bus and larger shared bus configurations may also be employed. Alternatively a serial bus is also used for the shared bus 120. Additionally, any combination of a parallel and serial bus may also be employed.

By having the highly integrated computer controlled headend 100 with the shared bus system, a variable quality of service (QoS) is achieved. The variable QOS differentiates between different types of data and the way the data is handled. By way of example Internet data may have an acceptable degree of delay between packets. However, voice applications can not have too much delay otherwise the quality of the voice signal is compromised. The highly integrated computer controlled headend 100 has the ability to guarantee the delivery of different types of data in a prescribed manner, and thereby meet variable QoS demands.

The highly integrated computer controlled headend 100 creates a highly flexible, scalable, and modular system design which is configured to run various applications. Additionally, the hardware platform can be configured to reduce the number of analog channels that need to be converted to digital channels thereby optimizing available bandwidth.

The software for the highly integrated computer controlled headend 100 comprises an advanced system software, a digital video broadcast module, and a CMTS headend router software module. The advanced system software wraps around the highly integrated computer controlled headend 100 and controls the advanced digital down stream data module 160a through 160n and the integrated bi-directional signaling and control module 164. In addition, the advanced operating system software creates an applications program interface (API) where external software modules can be inserted and used to run digital applications.

The digital video broadcast module expands the number of broadcast channels it offers and needs only the advanced digital down stream data module to be operational. This module is compatible with the plurality of digital set-top boxes.

The CMTS headend router software module is used to control and manage the advanced digital down stream data module and the integrated bi-directional signaling and control module. The CMTS headend router software provides router functionality to the highly integrated computer controlled headend by controlling encoding, encapsulation, error correction, handshaking, and communications protocols used by DOCSIS.

Alternatively, it shall be appreciated by those skilled in the art having the benefit of this disclosure that each of the individual smart NIMs 126, 128, 134, 138, 140 146, 148 and 150 can be combined in an aggregated smart NIM 130. Furthermore, it shall be appreciated by those skilled in the art having the benefit of this disclosure that any combination of individual smart NIMs and aggregated smart NIMs can be used to accomplish the same objective as described herein.

The digital headend 100 comprises a highly integrated system having a first-level buffering operation which operates in a shared bus environment. The first level buffering provides buffers and generates a destination address associated with a particular downstream module.

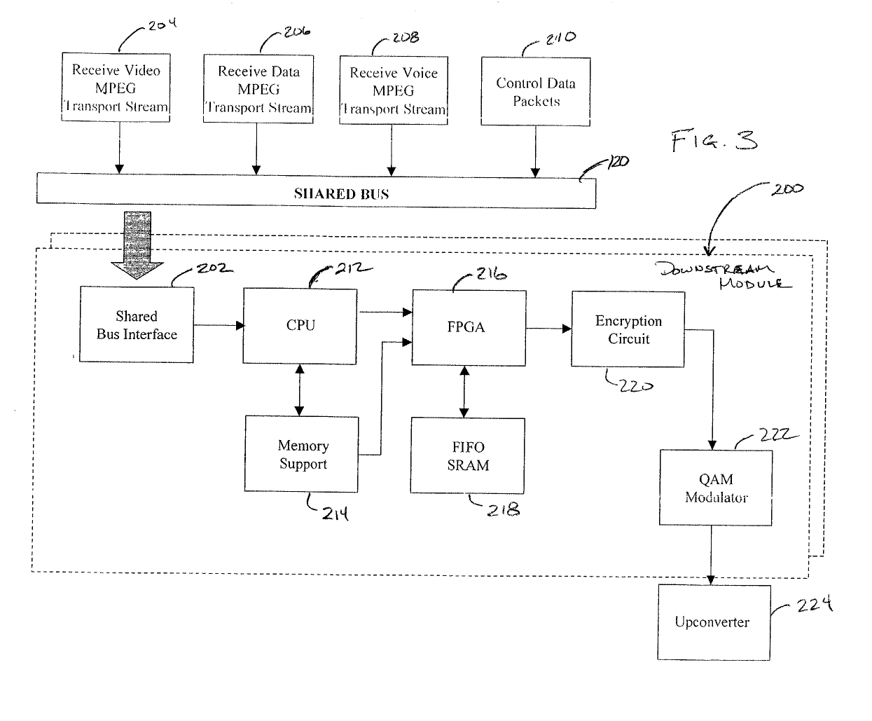

FIG. 3 is a block diagram of a downstream module. The downstream module 200 includes a shared bus interface 202 which interfaces with the shared bus 120. Preferably, the shared bus 202 receives video MPEG transport stream packets 204, data MPEG transport stream packets 206, voice MPEG transport stream packet 208, and control data packets 210.

Referring to FIG. 3 as well as FIG. 2, the video stream packets 204 are generated by the video server 144 and the Analog Conversion Computer 136. The data transport stream packets 206 are communicated by the Internet Processing and Management computer 122. The voice transport stream packets are communicated by the telephone processing and management system 124. The control data packets are generated by the control computer 142 and by any other computer which is configured to generate control packets.

Preferably, the smart network interface module generates a destination address for each stream packet. The destination address identifies the downstream module which will be processing the stream packet. Preferably, the smart network interface module is configured to receive an MPEG-2 transport packet and is configured to determine which downstream module is the target for the MPEG-2 transport packet. The selected downstream module is informed that a packet is ready and the location of the packet.

Referring back to FIG. 3, the downstream module 200 includes a shared bus interface 202, a CPU 212, a memory support module for CPU 214, a programmable logic which is referred to as a field programmable gate array (FPGA) 216, a first-in-first-out (FIFO) SRAM 218, an encryption circuit 220, and a downstream modulator 222. The downstream modulator output is communicated to an upconverter 224.

The CPU 212 is operatively coupled to the shared bus interface 202. The CPU 212 is configured to combine the plurality of transport packets to generate a programmable CPU output which is communicated to a programmable logic 216 which is also referred to as the field programmable gate array. The memory support module 214 which provides memory resources for the CPU 212 is also in communication with the programmable logic 216. The FIFO SRAM 218 is a static RAM which stores the transport packets provided by the programmable logic into the SRAM 218. Once the SRAM is filled, the SRAM transport packets are then communicated via the programmable logic 216 to the encryption circuit 220. The encryption circuit 220 encrypts the transport packets and then communicates the output to the downstream modulator 222. The downstream modulator 222 is preferably a QAM modulator. However, the downstream modulator may also be a QPSK modulator. It shall be appreciated by those skilled in the art that a downstream modulator includes QAM modulation, QPSK modulation and any other such modulating means well known to those in the art. The downstream modulator output is then communicated to an upconverter 224 which selects the appropriate channel for the downstream communications.

Once the downstream module 200 receives the transport packet, the CPU 212 processes each transport stream packet and combines the video, data or voice streams or any combination thereof. The combination of the CPU 212 and memory support 214 act as a re-packetization module which is configured to combine the plurality of video packets, the plurality of data packets, the plurality of voice or the plurality of control packets so that communications using one channel is provided as described in further detail below. More, particularly, the processor combines the different data streams by generating a pointer list and then generating a packet pointer priority list. Preferably, each transport stream packet is a 188 byte MPEG-2 transport stream packet. The CPU 212 also performs the functions of placing the transport packets in a memory support 214. Preferably, the memory support 214 is a SRAM. Additionally, the CPU 212 is configured to compare video program presentation times with those of either data or voice signals or any combination thereof.

The CPU then reads the packet pointer list and moves each MPEG-2 transport packet from the CPU 212 or the memory support 214 to the programmable logic 216 in single byte instructions having a memory 218 which is preferably a FIFO SRAM. The combination of the programmable logic 216 and a FIFO SRAM 218 perform as a synchronizing module. The synchronizing module generates a synchronous output that includes the video packets, the data packets, the voice packets, the control packets, or any combination thereof. More particularly, the single byte instructions are then stored in the FIFO SRAM 218. Once the stack in the FIFO SRAM is filled, the FIFO SRAM is emptied and the output generated is a synchronous output of 188 byte packets.

Preferably, the CPU 212 is a Motorola MPC8240 IC which combines the processing speed of the Power PC CPU with a high performance memory controller and includes a shared bus interface. It is preferable to combine all these functions on to one chip to save circuit board space and simplifies design.

It shall be appreciated by those skilled in the art that the programmable logic in the embodiment is a FPGA which controls the packet FIFO and generates a serial data stream via the FIFO SRAM 218. The serial data stream is a synchronous data stream which is, preferably, comprised of 188 byte MPEG-2 transport packets. It is also preferable that encryption functions will be applied to the serial data stream in the programmable logic 216.

Preferably, the downstream modulator 222 is a Broadcom BCM3033 IC which provides either 64 QAM or 256 QAM modulation. It shall be appreciated by those skilled in the art that the Broadcom chip also inserts null packets where needed as well as tending to the interleaving and forward error correction.

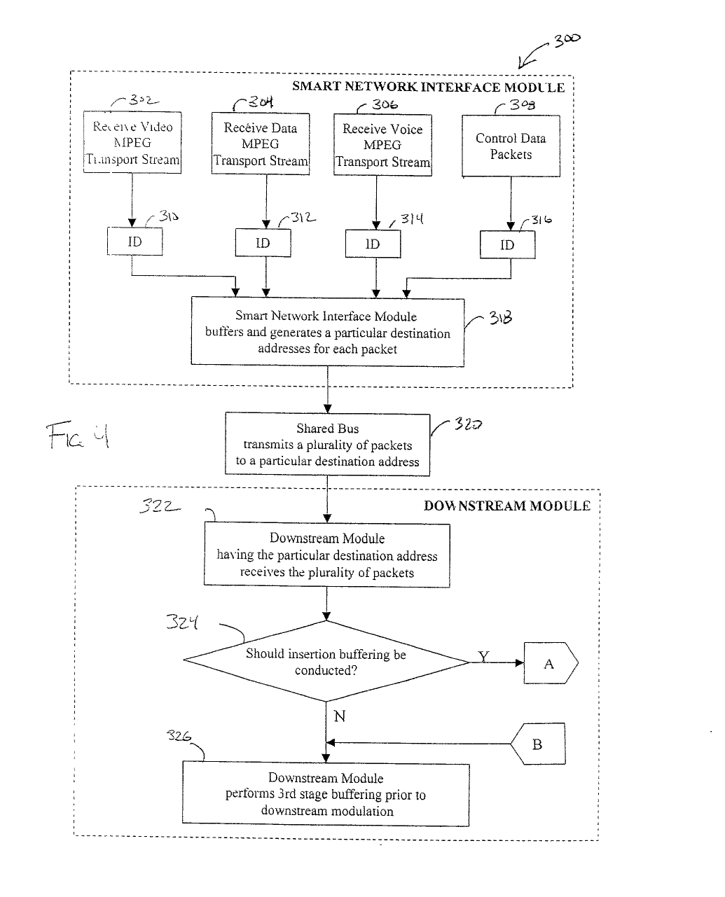

FIG. 4 is a flow diagram of a downstream module in communication with a smart network interface module. The flow diagram 300 shows the data flow from a smart network interface module via a shared bus 120 to a downstream module. Preferably, the smart network interface modules of FIG. 2 receives video MPEG transport stream packets 302, data MPEG transport stream packets 304, voice MPEG transport stream packet 306, and control data packets 308. Each of the video, data, voice and control transport streams has an associated identity which is communicated to the smart network interface module. Preferably the video transport stream 302 is provided with an identity 310, the data transport stream is provided with an identity 312, the voice transport stream 306 is provided with an identity 314, and the control data packets 308 are provided with an identity 316. The smart network interface module then performs a first stage buffering of the various data streams. Additionally, the smart network interface card is configured to receive an acknowledgement regarding availability from a downstream module for one or more identified transport streams. The smart network interface card then proceeds to generate a particular destination address 318 which identifies a particular downstream module which communicated the acknowledgement.

At block 320, a shared bus 120 then transmits a plurality of packets to the particular destination address which is associated with the selected downstream module.

At block 322, the selected downstream module having the particular destination address receives the plurality of transport packets. Referring to FIG. 3 as well as FIG. 4, the transport packets are received by the CPU 212 via the shared bus interface 202. The method then proceeds to decision diamond 324.

At decision diamond 324, the CPU 212 determines whether insertion buffering should be conducted. Insertion buffering includes the addition of control data packets to an existing transport stream, or the inclusion of bit stuffing, or the application of byte insertions. If the CPU 212 determines that insertion buffering is NOT required, then a multiplex of transport packets generated by CPU 212 are communicated to blcok 326. If the CPU 212 determines that insertion buffering is required, then a multiplex of transport packets are communicated to decision diamond 332.

At block 326, the CPU 212 communicates the multiplex of transport packets to the programmable logic 216 and the FIFO SRAM 218. Preferably, the programmable logic 216 output is a synchronous MPEG-2 output of transport packets as described above. The programmable logic and the FIFO SRAM perform a third buffering stage prior to downstream modulation which combines the output generated by the CPU 212 and the memory support module 214. The third buffering stage generates a synchronous output of 188 byte transport packets for downstream transmission.

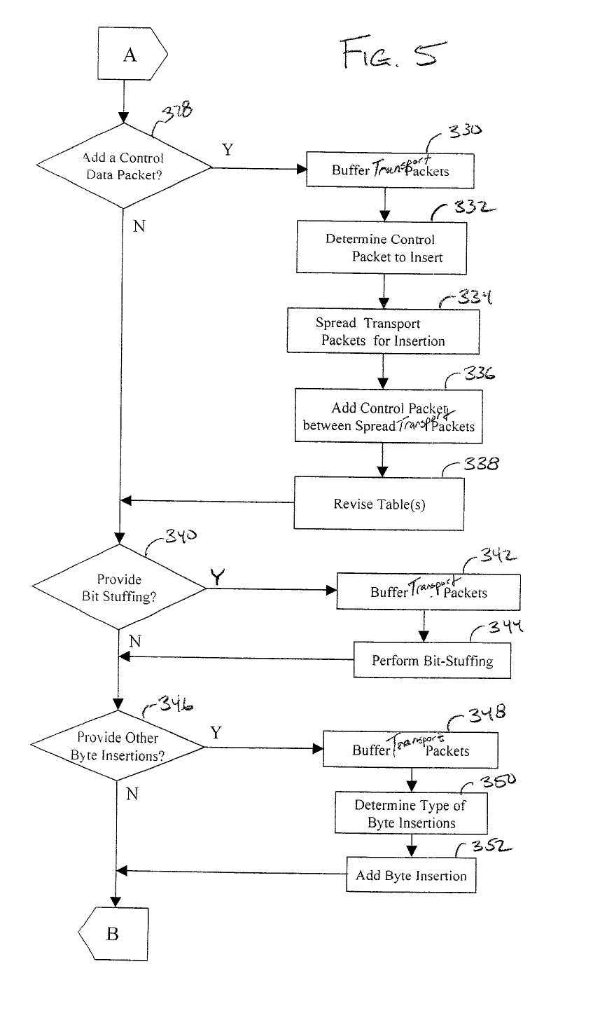

FIG. 5 is a flow diagram of the insertion of packets, bits, and bytes to an existing transport stream by the CPU 212. The insertion of packets is initiated by having made a positive determination that the insertion buffering should conducted as provided by decision diamond 324 of FIG. 4. The method then proceeds to proceeds to decision diamond 328 in which it is determined whether a control data packet should be inserted into the transport stream. If a determination is made that a control data packet should be inserted into the transport stream, the method proceeds to block 330.

At block 330, the memory support module 214 buffers the transport packets. The transport packets may include video transport packets, data transport packets, voice transport packets, or any combination thereof. After the transport packets have been buffered the method proceeds to block 332.

At block 332, the CPU 212 determines which one or more control packets are to be inserted and where one or more control packets are to be inserted into the transport packet stream. The determination may be based on timing intervals, or identification, or on a priority basis, or may be flagged, or any such other combination or determining means well known to those skilled in the art. The method then proceeds to block 334.

At block 334, the CPU 212 spreads the transport packet stream apart. The transport packets are spread apart sufficiently to provide for the insertion of control packets. The method then proceeds to block 336. At block 336, the CPU 212 adds or inserts the one or more control packets between the spread transport packets. The method then proceeds to block 338 in which tables are revised to reflect the insertion of control packets to the transport stream. The method then proceeds to decision diamond 340.

If at decision diamond 328 a determination is made that the addition of a control packet is NOT required, then the method proceeds to decision diamond 340.

At decision diamond 340 it is determined whether to perform bit stuffing. It shall be appreciated by those skilled in the art that bit stuffing is a well-known technique of adding null packets to the data payload portion of a transport packet. Bit stuffing is used to ensure that evenly sized packets are generated. If a determination is made at decision diamond that bit stuffing is required, then the method proceeds to block 342.

At block 342, the CPU 212 buffers transport packets. The transport packets may include control packets. The method then proceed to block 344 in which bit-stuffing is performed. Once the bit-stuffing is performed the method proceeds to decision diamond 346.

If at decision diamond 340 a determination is made that bit stuffing is NOT required, then the method proceeds to decision diamond 346.

At decision diamond 346 a determination is made as to whether other byte insertions need to be inserted into the transport packets. If it is determined that byte insertions are required to be inserted into the transport packets then the method proceed to block 348. At block 348, the transport packets are buffered and proceed to block 350. At block 350 a determination is made of the type of byte insertion to include in the transport packet. The byte insertion may be video, data, voice or control byte insertion or any combination thereof. The method the proceed to block 352 in which the byte insertion is accomplished. Once the byte insertion has been completed the method proceeds to block 326 as described above.

If a determination is made at decision diamond 346, that no byte insertions are necessary, then the method proceeds to block 326 as described above.

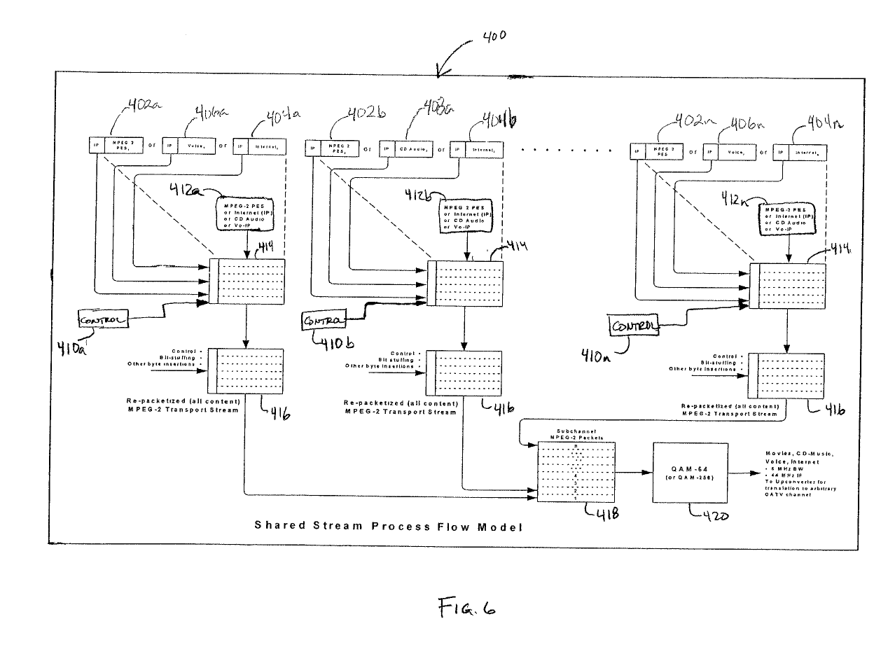

FIG. 6 is a process flow diagram 400 of the multi-tier buffering system used in digital headend 100. The multi-tier buffering system communicates a plurality of video packets, a plurality of data packets, a plurality of voice packets, a plurality of control packets, or any combination thereof. In the illustrative embodiment provided by FIG. 6, the plurality video packets 402a, 402b, and 402n are communicated to the digital head as video packets having IP headers. In the illustrative embodiment, a plurality of data packets are described as “Internet” data payloads and include data packets 404a, 404b and 404n which are communicated as data packets having IP headers. Voice data packets 406a and 406n which include VoIP (voice over IP) or switched telephony are communicated using IP headers. Furthermore, CD quality audio packets 408a are also communicated using IP headers. It shall be appreciated by those skilled in the art that CD quality audio packets may also be referred to as data packets. Further still, control data packets 410a, 410b, and 410n are generated by the digital headend 100 to manage the video packets, data packets, voice packets and audio packets. The plurality of video packets, data packets, and voice packets may also be communicated as MPEG-2 packetized elementary streams (PES) 412a, 412b, and 412n which include video packets, data packets, voice packets and CD-audio packets. It shall be appreciated by those skilled in the art having the benefit of this disclosure that the type of protocol for communication of the video, data, or voice packets is not a necessary limitation of the invention and the reference to IP headers and MPEG-2 packets is intended to describe the general concept of headend which is configured to receive data payloads which are communicated differently.

Referring back to FIG. 2, the digital headend 100 includes at least one buffering module which receives the plurality of video packets, the plurality of data packets, the plurality of voice packets, and the plurality of control packets. In the embodiment provided in FIG. 2, a plurality of buffering modules are identified as smart network interface modules 126, 128, 134, 138, 140, 146, 148 and 150. A plurality of first buffering modules 138, 140, 148, and 150 are configured to receive a plurality of video packets. Additionally, a second buffering module 126 is configured to receive a plurality of data packets. Furthermore, a third buffering module 128 is configured to receive a plurality of voice packets. Finally, a fourth buffering module 146 is configured to receive a plurality of control packets.

In the illustrative data flow provided in FIG. 6, the buffering module 414 receives a plurality of video packets, data packets, voice packets and control packets. The buffering module 414 represents the general concept of providing a “buffer” or data storage location for the video packets, data packets, voice packets or control packets. More particularly, the one or more video packets 402a, 402b, 402n, 412a, 412b, or 412n are buffered in buffering module 414. The one or more data packets 404a, 404b, 404n, 412a, 412b, or 412n are buffered in buffering module 414. The one or more voice packets 406a, 406n, 412a, 412b, or 412n and the CD-audio packets 408a are also buffered in the buffering module 414. Finally, the control packets 410a, 410b and 410n are also buffered in buffering module 414.

The buffering module 414 also provides the additional function of providing the destination address for the submission of video, data, voice, or control packets to the selected or determined downstream module 160a, 160, or 166 (see FIG. 2). A more detailed representation of the downstream module is shown in FIG. 3. The downstream module includes a re-packetization module 416 which receives the video, data, voice, or control packets having the appropriate destination address and, preferably, includes a CPU 212 and memory support 214 The re-packetization module 416 is configured to combine the plurality of video packets, the plurality of data packets, the plurality of voice or the plurality of control packets so that communications using one channel is provided. The re-packetization module also performs the function of determining whether insertion buffering should be used as described in FIG. 4 and FIG. 5.

The output from the re-packetization module 416 is then communicated to a synchronizing module 418 which generates a synchronous output that includes the video packets, the data packets, the voice packets, the control packets, or any combination thereof. As described above, the synchronization module includes a programmable logic 216 and a memory 218 which is preferably a FIFO SRAM as shown in FIG. 2.

Referring to FIG. 2, it shall be appreciated by those skilled in the art having the benefit of this disclosure that the digital headend 100 includes a plurality of downstream modules 160a through 160n and 166. Each downstream module occupies a single communications channel and includes its own re-packetization module and synchronization module. Additionally, the transmission of each packet to the appropriate downstream module is determined by the smart network interface module which provides a destination address identifying the downstream module.

Preferably, the video, data and voice packets are communicated as MPEG transport stream packets. However, it shall be appreciated by those skilled in the art that other transport protocols for communicating the data payloads resident in the video, data and voice packets may also be employed.

The output from the synchronization module 418 is then communicated to a downstream modulator 420 which is preferably a QAM modulator. The QAM modulator output is then upconverted as previously described.

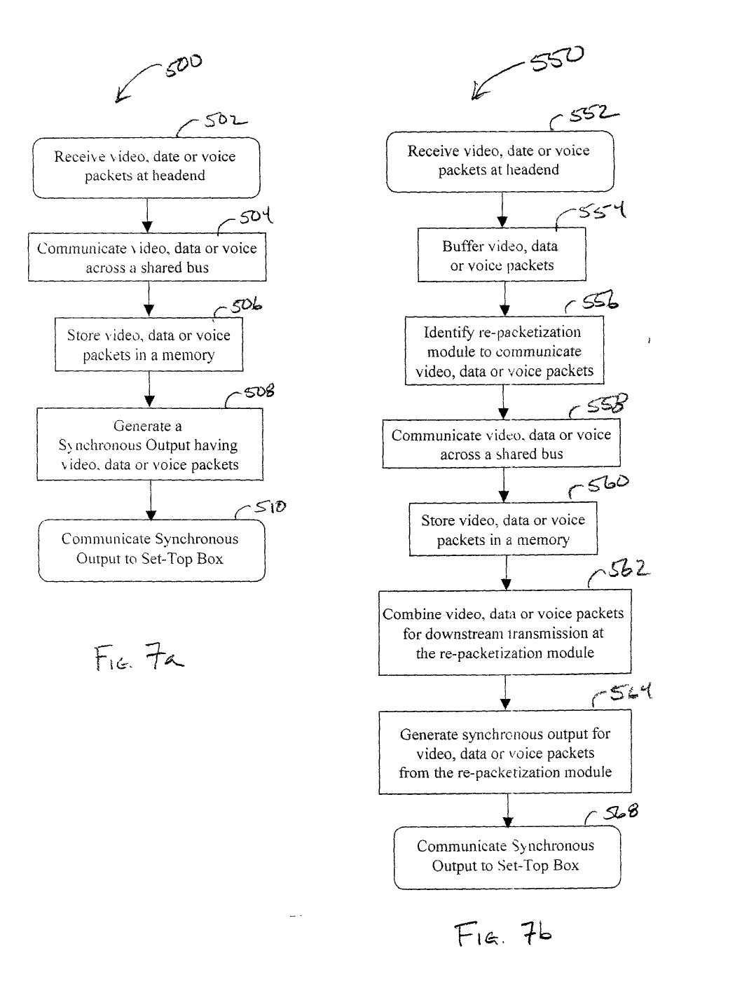

FIG. 7a is flow diagram of the data flow within the digital headend which generates a synchronous output from asynchronous input. More particularly, the flow diagram describes a method 500 for communicating asynchronous video packets, data packets, voice packets, and control packets in a single communications channel. The method includes the step 502 of receiving a plurality of video packets, a plurality of data packets, a plurality of voice packets, a plurality of control packets, or a combination thereof. The method then proceeds to block 504.

At block 504 the video, data, voice, or control packets are communicated across a shared bus interface to a downstream module. Referring to FIG. 3 there is shown an illustrative downstream module 200. The digital headend comprises a plurality of downstream modules. The selection of the appropriate downstream module is determined by providing a destination address to each packet which identifies a particular downstream module. Referring to FIG. 3 as well as FIG. 6, each packet is then communicated to downstream module having a CPU 212 and a memory support module 214 which are both referred to as a re-packetization module 416. The re-packetization module output is then communicated to synchronization module 418 which includes a FIFO memory buffer 218 referred to also as an FIFO SRAM.

At block 506, the packets of video, data, voice, control, or any combination thereof are stored in the FIFO memory buffer 218. The method then proceeds to block 508.

At block 508, a synchronous output having video, data or voice packets are communicated by the illustrative downstream modulator 200. The flow of video, data, voice or control packets to the FIFO memory buffer 218 are regulated by the processor 212, the programmable logic 216, and the memory support module 214. The FIFO memory buffer 218 generates a synchronous output having video, data, voice, or control packets. The synchronous output is preferably a stream of MPEG-2 transport packets. The method then proceeds to block 510.

At block 510, the synchronous output is communicated to a set-top box. The synchronous output is preferably communicated as MPEG-2 transport packets.

Alternatively, FIG. 7b provides a flow diagram of the multi-tier buffering method 550 for the digital headend 100. The multi-tier method is preferably a three step buffering process which includes buffering packets, combining packets and generating a synchronous output of packets. Similar to FIG. 7a, the flow chart provides a method 550 for communicating asynchronous video packets, data packets, voice packets, control packets or any combination thereof using a single communications channel. The method includes the step 552 of receiving a plurality of video packets, a plurality of data packets, a plurality of voice packets, a plurality of control packets, or a combination thereof. The method then proceeds to block 554.

At block 554, the first stage buffering is accomplished in which the packets video, data, voice, or control packets are buffered. Preferably, the buffering occurs at the smart network interface module as described above. The method then proceeds to block 556.

At block 556, a downstream module having a particular re-packetization module is identified using a destination address as described above. The downstream module includes a re-packetization module which combines the packets of video, data, voice, or control packets. Once the destination address is associated with each packet, then the method proceeds to block 558.

At block 558 the video, data, voice, or control packets are communicated across a shared bus interface to a downstream module. Referring to FIG. 3 there is shown an illustrative downstream module 200. The digital headend comprises a plurality of downstream modules. The selection of the appropriate downstream module is determined by providing a destination address to each packet which identifies a particular downstream module. Referring to FIG. 3 as well as FIG. 6, each packet is then communicated to downstream module having a CPU 212 and a memory support module 214 which are both referred to as a re-packetization module 416. The re-packetization module output is then communicated to synchronization module 418 which includes a FIFO memory buffer 218 referred to also as an FIFO SRAM.

At block 560, the packets of video, data, voice, control, or any combination thereof are stored in a memory support module 214 and processed by the CPU 212. At block 562, the CPU 212 combines the packets of video, data, voice, control or any combination thereof. The combination of CPU 212 and memory support module 214 are referred to as the re-packetization module. The re-packetization module performs the second tier buffering. The method then proceed to block 564.

At block 564, a synchronous output having video, data or voice packets are communicated by the illustrative downstream modulator 200. The flow of video, data, voice or control packets to the FIFO memory buffer 218 are regulated by the processor 212, the programmable logic 216, and the memory support module 214. The FIFO memory buffer 218 generates a synchronous output having video, data, voice, or control packets. The synchronous output is preferably a stream of MPEG-2 transport packets. The synchronization module performs the third tier buffering. The method then proceeds to block 568.

At block 568, the synchronous output is communicated to a set-top box. The synchronous output is preferably communicated as MPEG-2 transport packets.

Since the digital headend 100 is a programmable digital headend, the digital headend 100 may be programmed to process: video, data and voice packets; video and data packets; video and voice packets; data and voice packets; video only packets; data only packets; or voice only packets. It shall be appreciated by those skilled in the art that each communications channel may also be configured to communicate either one of these combinations of video, data and voice packets.

While embodiments and applications of this invention have been shown and described, would be apparent to those skilled in the art that many more modifications than mentioned above are possible without departing form the inventive concepts herein. The invention, therefore, is not to be restricted except in the spirit of the appended claims.

What is claimed is:

1. A digital headend system for communicating a plurality of video packets, a plurality of data packets, a plurality of voice packets, and a plurality of control packets, comprising:
a buffering module configured to receive said plurality of video packets, said plurality of data packets, said plurality of voice packets, and said plurality of control packets;
a first re-packetization module in communication with said buffering module, said first re-packetization module configured to combine said plurality of video packets, said plurality of data packets, said plurality of voice packets, and said plurality of control packets to generate a first re-packetization module output; and
a first synchronizing module configured to receive said first re-packetization output and configured to generate a first synchronous output stream having said plurality of video packets, said plurality of data packets, said plurality of voice packets and said plurality of control packets.

2. The digital headend system of claim 1 wherein said buffering module further comprises:
a first buffering module configured to receive a first plurality of video packets;
a second buffering module configured to receive a first plurality of data packets;
a third buffering module configured to receive a first plurality of voice packets; and
a fourth buffering module configured to receive a first plurality of control packets.

3. The digital headend system of claim 2 wherein said first buffering module, said second buffering module, said third buffering module, and said fourth buffering module each are configured to generate a destination address which identifies said first re-packetization module.

4. The digital headend system of claim 2 further comprising a second re-packetization module in communication with said first, second, third, and fourth buffering module, said second re-packetization module configured to combine said plurality of video packets, said plurality of data packets, said plurality of voice packets, and said plurality of control packets to generate a second re-packetization module output.

5. The digital headend system of claim 4 wherein said first buffering module, said second buffering module, said third buffering module, and said fourth buffering module each are configured to generate a destination address which identifies said second re-packetization module.

6. The digital headend system of claim 5 further comprising a second synchronization module configured to receive said second re-packetization module output, said second sychronization module configured to generate a synchronous output stream having said plurality of video packets, said plurality of data packets, said plurality of voice packets and said plurality of control packets.

7. The digital headend system of claim 1 wherein each of said plurality of video packets are MPEG transport stream packets.

8. The digital headend system of claim 7 wherein each of said plurality of data packets are MPEG transport stream packets.

9. The digital headend system of claim 8 wherein each of said plurality of voice packets are MPEG transport stream packets.

10. The digital headend system of claim 1 wherein said first synchronous output stream occupies one channel.

11. A digital headend system for communicating a plurality of video packets, a plurality of data packets, and a plurality of control packets, comprising:
a buffering module configured to receive said plurality of video packets, said plurality of data packets, and said plurality of control packets;
a first re-packetization module in communication with said buffering module, said first re-packetization module configured to combine said plurality of video packets, said plurality of data packets, and said plurality of control packets to generate a first re-packetization module output; and
a first synchronizing module configured to receive said first re-packetization output and configured to generate a first synchronous output stream having said plurality of video packets, said plurality of data packets, and said plurality of control packets.

12. The digital headend system of claim 11 wherein said buffering module further comprises:
a first buffering module configured to receive a first plurality of video packets;
a second buffering module configured to receive a first plurality of data packets; and
a third buffering module configured to receive a first plurality of control packets.

13. The digital headend system of claim 12 wherein said first buffering module, said second buffering module, and said third buffering module each are configured to generate a destination address which identifies said first re-packetization module.

14. The digital headend system of claim 12 further comprising a second re-packetization module in communication with said first, second, and third buffering module, said second re-packetization module configured to combine said plurality of video packets, said plurality of data packets, and said plurality of control packets to generate a second re-packetization module output.

15. The digital headend system of claim 14 wherein said first buffering module, said second buffering module, and said third buffering module each are configured to generate a destination address which identifies said second re-packetization module.

16. The digital headend system of claim 15 further comprising a second synchronization module configured to receive said second re-packetization module output, said second sychronization module configured to generate a synchronous output stream having said plurality of video packets, said plurality of data packets, and said plurality of control packets.

17. The digital headend system of claim 11 wherein each of said plurality of video packets are MPEG transport stream packets.

18. The digital headend system of claim 17 wherein each of said plurality of data packets are MPEG transport stream packets.

19. The digital headend system of claim 11 wherein said synchronization module is a programmable logic module having a memory module.

20. The digital headend system of claim 11 wherein said first synchronous output stream occupies one channel.

21. A digital headend system for communicating a plurality of video packets, a plurality of voice packets, and a plurality of control packets, comprising:
a buffering module configured to receive said plurality of video packets, said plurality of voice packets, and said plurality of control packets;
a first re-packetization module in communication with said buffering module, said first re-packetization module configured to combine said plurality of video packets, said plurality of voice packets, and said plurality of control packets to generate a first re-packetization module output; and
a synchronizing module configured to receive said first re-packetization output and configured to generate a first synchronous output stream having said plurality of video packets, said plurality of voice packets and said plurality of control packets.

22. The digital headend system of claim 1 wherein said buffering module further comprises:
a first buffering module configured to receive a first plurality of video packets;
a second buffering module configured to receive a first plurality of voice packets; and
a third buffering module configured to receive a first plurality of control packets.

23. The digital headend system of claim 22 wherein said first buffering module, said second buffering module, and said third buffering module each are configured to generate a destination address which identifies said first re-packetization module.

24. The digital headend system of claim 22 further comprising a second re-packetization module in communication with said first, second, and third buffering module, said second re-packetization module configured to combine said plurality of video packets, said plurality of voice packets, and said plurality of control packets to generate a second re-packetization module output.

25. The digital headend system of claim 24 wherein said first buffering module, said second buffering module, and said third buffering module each are configured to generate a destination address which identifies said second re-packetization module.

26. The digital headend system of claim 25 further comprising a second synchronization module configured to receive said second re-packetization module output, said second sychronization module configured to generate a synchronous output stream having said plurality of video packets, said plurality of voice packets, and said plurality of control packets.

27. The digital headend system of claim 21 wherein each of said plurality of video packets are MPEG transport stream packets.

28. The digital headend system of claim 27 wherein each of said plurality of voice packets are MPEG transport stream packets.

29. The digital headend system of claim 21 wherein said synchronization module is a programmable logic module having a memory module.

30. The digital headend system of claim 21 wherein said first synchronous output stream occupies one channel.

31. A method for communicating a plurality of video packets, a plurality of data packets, a plurality of voice packets, and a plurality of control packets, comprising:
receiving said plurality of video packets, said plurality of data packets, said plurality of voice packets, and said plurality of control packets;
communicating said plurality of video packets, said plurality of data packets, said plurality of voice packets, and said plurality of control packets across a shared bus; and
processing said plurality of video packets, said plurality of data packets, said plurality of voice packets, and said plurality of control packets communicated across said shared bus to occupy one communications channel.

32. The method of claim 31 further comprising,
generating a synchronous output stream for said plurality of video packets, said plurality of data packets, said plurality of voice packets, and said plurality of control packets.

33. The method of claim 31 wherein said receiving said plurality of video packets, said plurality of data packets, said plurality of voice packets, and said plurality of control packets, further comprises:
buffering said plurality of video packets, said plurality of data packets, said plurality of voice packets, and said plurality of control packets; and
identifying a re-packetization module to communicate said plurality of video packets, said plurality of data packets, said plurality of voice packets, and said plurality of control packets.

34. The method of claim 31 wherein said processing said plurality of video packets, said plurality of data packets, said plurality of voice packets, and said plurality of control packets, further comprises:
combining said plurality of video packets, said plurality of data packets, said plurality of voice packets, and said plurality of control packets in a re-packetization module to generate a re-packetization output; and
generating a synchronous output stream from said first re-packetization output.

35. The method of claim 33 wherein said processing said plurality of video packets, said plurality of data packets, said plurality of voice packets, and said plurality of control packets, further comprises:
combining said plurality of video packets, said plurality of data packets, said plurality of voice packets, and said plurality of control packets in said re-packetization module to generate a re-packetization output; and
generating a synchronous output stream from said first re-packetization output.

36. A method for communicating a plurality of video packets, a plurality of data packets, and a plurality of control packets, comprising:
receiving said plurality of video packets, said plurality of data packets, and said plurality of control packets;
communicating said plurality of video packets, said plurality of data packets, and said plurality of control packets across a shared bus; and
processing said plurality of video packets, said plurality of data packets, and said plurality of control packets communicated across said shared bus to occupy one communications channel.

37. The method of claim 36 further comprising,
generating a synchronous output stream for said plurality of video packets, said plurality of data packets, and said plurality of control packets.

38. The method of claim 36 wherein said receiving said plurality of video packets, said plurality of data packets, and said plurality of control packets, further comprises:
buffering said plurality of video packets, said plurality of data packets, and said plurality of control packets; and
identifying a re-packetization module to communicate said plurality of video packets, said plurality of data packets, and said plurality of control packets.

39. The method of claim 36 wherein said processing said plurality of video packets, said plurality of data packets, and said plurality of control packets, further comprises:
combining said plurality of video packets, said plurality of data packets, and said plurality of control packets in a re-packetization module to generate a re-packetization output; and
generating a synchronous output stream from said first re-packetization output.

40. The method of claim 38 wherein said processing said plurality of video packets, said plurality of data packets, and said plurality of control packets, further comprises:
combining said plurality of video packets, said plurality of data packets, and said plurality of control packets in said re-packetization module to generate a re-packetization output; and

41. A method for communicating a plurality of video packets, a plurality of voice packets, and a plurality of control packets, comprising:
receiving said plurality of video packets, said plurality of voice packets, and said plurality of control packets;
communicating said plurality of video packets, said plurality of voice packets, and said plurality of control packets across a shared bus; and
processing said plurality of video packets, said plurality of voice packets, and said plurality of control packets communicated across said shared bus to occupy one communications channel.

42. The method of claim 41 further comprising,
generating a synchronous output stream for said plurality of video packets, said plurality of voice packets, and said plurality of control packets.

43. The method of claim 41 wherein said receiving said plurality of video packets, said plurality of voice packets, and said plurality of control packets, further comprises:
buffering said plurality of video packets, said plurality of voice packets, and said plurality of control packets; and
identifying a re-packetization module to communicate said plurality of video packets, said plurality of voice packets, and said plurality of control packets.

44. The method of claim 41 wherein said processing said plurality of video packets, said plurality of voice packets, and said plurality of control packets, further comprises:
combining said plurality of video packets, said plurality of voice packets, and said plurality of control packets in a re-packetization module to generate a re-packetization output; and
generating a synchronous output stream from said first re-packetization output.

45. The method of claim 43 wherein said processing said plurality of video packets, said plurality of voice packets, and said plurality of control packets, further comprises:
combining said plurality of video packets, said plurality of data packets, and said plurality of control packets in said re-packetization module to generate a re-packetization output; and
generating a synchronous output stream from said first re-packetization output.
